(19) United States
(12) Patent Application Publication
(10) Pub. No.: US 2016/0076334 A1
(43) Pub. Date: Mar. 17, 2016

(54) TOPSIDE PRESSURE PROTECTION SYSTEM

(71) Applicant: TRENDSETTER VULCAN OFFSHORE, INC., Houston, TX (US)

(72) Inventor: James V. Maher, Houston, TX (US)

(73) Assignee: TRENDSETTER VULCAN OFFSHORE, INC.

(21) Appl. No.: 14/857,265

(22) Filed: Sep. 17, 2015

Related U.S. Application Data
(60) Provisional application No. 62/051,382, filed on Sep. 17, 2014.

(51) Int. Cl. E21B 34/04; G05D 16/20

(52) U.S. Cl. CPC E21B 34/04; G05D 16/2013

(57) ABSTRACT

A pressure protection system includes a valve and a pipe bundle. A plurality of pressure sensors is coupled to the valve and communicatively coupled to a logic controller. The logic controller is operable to close the valve upon sensing a pressure above a predetermined limit. The pipe bundle includes a cylindrical coil of pipe that, in certain embodiments, may surround a riser or a wellhead.

### CROSS-REFERENCE TO RELATED APPLICATIONS

This application claims priority to U.S. provisional Pat. App. Ser. No. 62/051,382, filed on Sep. 17, 2014 and titled “Topside Pressure Protection System,” the content of which is incorporated herein by reference.

### BACKGROUND

This disclosure relates generally to methods and apparatus for controlling pressure during hydrocarbon exploration and production. More specifically, this disclosure relates to methods and apparatus for preventing over-pressurization of surface-mounted equipment during hydrocarbon exploration and production.

As hydrocarbon reservoirs of increasingly high pressures are explored and developed, there are increasing demands by governmental and regulatory authorities to improve safety by providing increased control of high pressure fluids. To this end, high integrity pressure protection systems (HIPPS) have been employed in the oil and gas industry to provide an additional barrier between equipment designed to contain high pressure and equipment that is not capable of containing high pressure.

Such systems may be employed on or near a subsea manifold that is coupled to production facility by a flowline. The manifold, and the wellheads coupled thereto, are designed to contain full wellbore pressure but the flowlines are rated to a lower pressure. The HIPPS, also rated to full wellbore pressure, forms part of the “fortified zone” and actuates automatically in response to excessive pressure so as to shut off any flow from the manifold before damaging the flowlines.

To achieve this, HIPPS conventionally include one or more valves that are actuated by a control system that monitors pressure immediately upstream or downstream of the valves. When the control system senses an excessive pressure, the valves are closed as quickly as possible. To accommodate the time that it will take to close the valves, subsea HIPPS often include a length of high pressure flowline designed to contain the increased pressure until the valves can be closed. The length of the high pressure flowline needed is dependent on the operating speed of the HIPPS as well as the expected flow conditions. In certain applications, the length of the high pressure flowline may be several hundred feet long.

In certain offshore installations, the wells are essentially extended to the surface platform and terminated in what are known as dry trees. In these installations, the high pressure equipment is located on the platform and connected to the seafloor by risers also rated for high pressure. The installation of a HIPPS downstream of a platform-mounted dry tree is complicated by the need for the extended high pressure “fortified zone” capable of containing high pressure until the HIPPS can be closed due to the relatively close spacing of equipment on the surface platform.

Thus, there is a continuing need in the art for methods and apparatus for providing increased safety and containment of high pressure in hydrocarbon exploration and production.

### BRIEF SUMMARY OF THE DISCLOSURE

In some aspects, a pressure protection system comprises a valve coupled to an inlet, a pipe bundle coupled to the valve and to an outlet, a plurality of pressure sensors coupled to the valve, and a logic controller communicatively coupled to the plurality of pressure sensors and operable to close the valve upon sensing a pressure above a predetermined limit. pipe bundle may include a coil of pipe having a central opening. The coil of pipe may be disposed around a dry tree. The coil of pipe may be disposed around a riser. The coil of pipe may be cylindrical. The inlet may be coupled to a dry tree. The system may further comprise a jumper, and the jumper may be coupled between the dry tree and the pipe bundle. The outlet may be coupled to a manifold. The system may further comprise a jumper, and the jumper may be coupled between the pipe bundle and the manifold.

In some aspects, a method of preventing over-pressurization of surface-mounted equipment comprises the steps of coupling a pipe bundle between the surface-mounted equipment and a pressure protection system having a valve, a plurality of pressure sensors coupled to the valve, and a logic controller communicatively coupled to the plurality of pressure sensors and operable to close the valve upon sensing a pressure above a predetermined limit, wherein the pressure protection system is coupled to a dry tree. The method may further comprise the step of coupling a flare between the pipe bundle and the surface-mounted equipment. The method may further comprise coupling a flare between the dry tree and the surface-mounted equipment. The surface-mounted equipment may comprise a manifold inlet.

In some aspects, a pressure protection system for use together with an active controlled valve comprises an inlet coupled to a dry tree, an outlet coupled to a manifold, and a pipe bundle coupled between the inlet and the outlet downstream of the active controlled valve. The pipe bundle may be disposed around one or more of a dry tree and a riser. The system may further comprise a flare coupled to the outlet of the pressure protection system. The system may further comprise a flare coupled to the inlet of the pressure protection system. The system may further comprise a valve coupled to the inlet, a plurality of pressure sensors coupled to the valve, and a logic controller communicatively coupled to the plurality of pressure sensors and operable to close the valve upon sensing a pressure above a predetermined limit. The pipe bundle may include a coil of pipe having a central opening. The coil of pipe may be cylindrical.

### BRIEF DESCRIPTION OF THE DRAWINGS

For a more detailed description of the embodiments of the present disclosure, reference will now be made to the accompanying drawings, wherein:

FIG. 1 is a schematic view of a topsides assembly including a HIPPS disposed between a dry tree and a jumper.

FIG. 2 is a partial isometric view of the system schematically shown in FIG. 1.

FIG. 3 is a schematic view of a topsides assembly including a HIPPS disposed downstream of a jumper.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

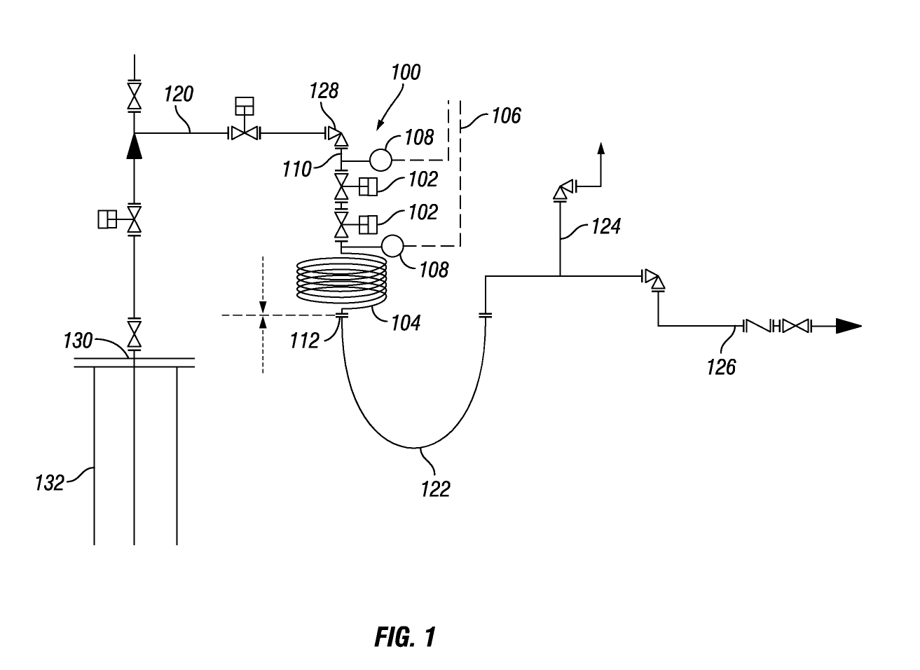

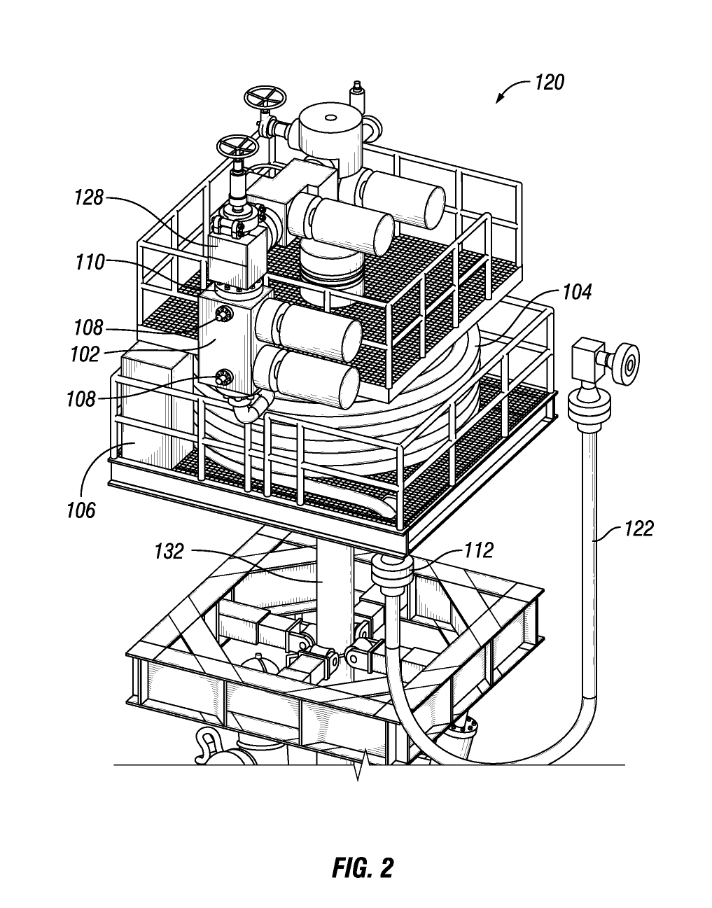

Referring initially to FIGS. 1 and 2, a pressure protection system 100 includes valves 102, pipe bundle 104, logic controller 106, and pressure sensors 108. The pressure protection system 100 is shown integrated into a system including a dry tree 120, jumper 122, flare 124, and manifold inlet 126. The pressure protection system 100 also includes an inlet 110 that is downstream of choke 128 and an outlet 112 that is upstream of jumper 122.

As used herein, a pipe bundle is a continuous pipe in which two or more portions of the pipe overlap or are doubled, such as by coiling, looping, folding or wrapping. A pipe bundle may be formed by bending the pipe, or by assembling (e.g., welding) preformed pipe sections, some of which being preformed with a curved shape, or by a combination of both bending and assembling. In any case, a pipe bundle is more compact than a straight pipe having the same length as the pipe bundle.

Valves 102 are connected in series and coupled to inlet 110. The valves 102 may be high-pressure gate valves, or some other type of valve, that can shut off flow through the pressure protection system 100 and are rated to handle the full pressure of the dry tree 120. Pipe bundle 104 is connected downstream of valves 102 and is coupled to outlet 112. Pipe bundle 104 is also rated to handle the full pressure of the dry tree 120, and has a length sufficient to contain an increased pressure in the pipe bundle 104 until the valves 102 can be closed. In operation, fluid flows from inlet 110 through valves 102 and pipe bundle 104 and into outlet 112.

In certain embodiments, the pipe bundle 104 may be a length of pipe or tubing that has been rolled into a substantially cylindrical coil, a substantially oval coil, a spiral coil, a coil made of stack of spirals, or a coil having another shape. The coil may have an open center that is free of pipe. As illustrated in FIG. 2, the dry tree 120, or the riser 132 onto which the dry tree 120 is coupled, may run through the center of the pipe bundle 104. In other embodiments, the pipe bundle 104 may have a different configuration or be disposed in a different location relative to the dry tree 120.

Pressure sensors 108 are disposed upstream and downstream of valves 102 and are operable to measure the pressure within the pressure protection system 100. Pressure sensors 108 are operably coupled to the logic controller 106. The logic controller 106 is programmed to monitor the pressure measured by pressure sensors 108. If the pressure measured by pressure sensors 108 exceeds a preset level, the logic controller 106 sends a signal that closes the valves 102. Once valves 102 are closed, jumper 122 and manifold inlet are isolated from the dry tree 120.

Dry tree 120 is coupled to a wellhead 130. The pressure protection system 100 is disposed in between the dry tree 120 and the jumper 122. In normal operation, choke 128 reduces the pressure from the dry tree 120 through the jumper 122 and the manifold inlet 126. Consequently, the jumper 122 and the manifold (not shown) are often designed to handle a pressure below the full pressure of the dry tree 120 to reduce the cost, size, and complexity of those components. Pressure protection system 100 thus provides an additional barrier between the high operating pressures of the dry tree 120 and the relatively lower operating pressures of the jumper 122 and the manifold.

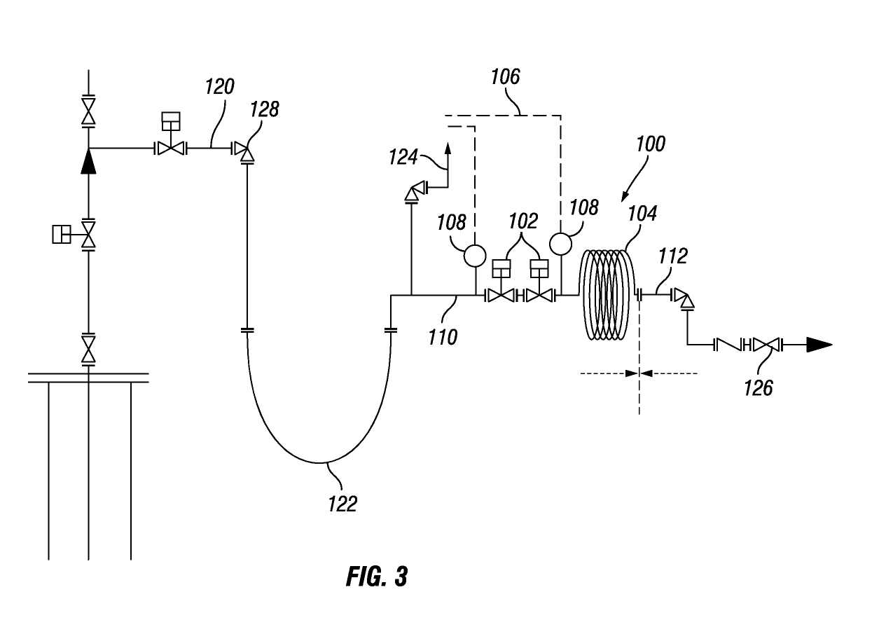

Referring now to FIG. 3, pressure protection system 100 is utilized with a system where the jumper 122 and flare 124 are rated for the full operating pressure of the dry tree 120. In this embodiments, pressure protection system 100 is disposed downstream of the flare 124 and upstream of the manifold inlet 126 to protect the manifold from excessive pressures. In other embodiments, pressure protection system 100 can be installed in other locations as alternatives, or in addition to, the illustrated configurations.

If the pressure measured by pressure sensors 108 exceeds a preset level, the logic controller 106 sends a signal that closes the valves 102. Once valves 102 are closed, the manifold inlet 126 is isolated from the dry tree 120. In this embodiment, jumper 122 is not isolated from the dry tree 120 and may experience higher pressure than in the embodiment shown in FIGS. 1 and 2. However, pressure at dry tree 120 may be dissipated in flare 124 even when valves 102 are closed.

While the disclosure is susceptible to various modifications and alternative forms, specific embodiments thereof are shown by way of example in the drawings and description. It should be understood, however, that the drawings and detailed description thereto are not intended to limit the disclosure to the particular form disclosed, but on the contrary, the intention is to cover all modifications, equivalents and alternatives falling within the spirit and scope of the present disclosure.

What is claimed is:

1. A pressure protection system comprising:
a valve coupled to an inlet;
a pipe bundle coupled to the valve and to an outlet;
a plurality of pressure sensors coupled to the valve; and
a logic controller communicatively coupled to the plurality of pressure sensors and operable to close the valve upon sensing a pressure above a predetermined limit.

2. The system of claim 1 wherein the pipe bundle includes a coil of pipe having a central opening.

3. The system of claim 2 wherein the coil of pipe is disposed around a dry tree.

4. The system of claim 2 wherein the coil of pipe is disposed around a riser.

5. The system of claim 2 wherein the coil of pipe is cylindrical.

6. The system of claim 1 where the inlet is coupled to a dry tree.

7. The system of claim 6 further comprising a jumper, wherein the jumper is coupled between the dry tree and the pipe bundle.

8. The system of claim 1 wherein the outlet is coupled to a manifold.

9. The system of claim 8 further comprising a jumper, wherein the jumper is coupled between the pipe bundle and the manifold.

10. A method of preventing over-pressurization of surface-mounted equipment comprising:
coupling a pipe bundle between the surface-mounted equipment and a pressure protection system having a valve, a plurality of pressure sensors coupled to the valve, and a logic controller communicatively coupled to the plurality of pressure sensors and operable to close the valve upon sensing a pressure above a predetermined limit,
wherein the pressure protection system is coupled to a dry tree.

11. The method of claim 10 further comprising:
coupling a flare between the pipe bundle and the surface-mounted equipment. The method of claim 10 further comprising:
coupling a flare between the dry tree and the surface-mounted equipment.

13. The method of claim 10 wherein the surface-mounted equipment comprises a manifold inlet.

14. A pressure protection system for use together with an active controlled valve comprising:
an inlet coupled to a dry tree;
an outlet coupled to a manifold; and
a pipe bundle coupled between the inlet and the outlet downstream of the active controlled valve.

15. The system of claim 14 wherein the pipe bundle is disposed around one or more of a dry tree and a riser.

16. The system of claim 14 further comprising a flare coupled to the outlet of the pressure protection system.

17. The system of claim 14 further comprising a flare coupled to the inlet of the pressure protection system.

18. The system of claim 14 further comprising:
a valve coupled to the inlet;
a plurality of pressure sensors coupled to the valve; and
a logic controller communicatively coupled to the plurality of pressure sensors and operable to close the valve upon sensing a pressure above a predetermined limit.

19. The system of claim 14 wherein the pipe bundle includes a coil of pipe having a central opening.

20. The system of claim 19 wherein the coil of pipe is cylindrical.
